(19) United States
(12) Patent Application Publication
(10) Pub. No.: US 2011/0047949 A1
(43) Pub. Date: Mar. 3, 2011

(54) DOUBLE TAPERED KNIFE ROLLS

(75) Inventors: James E. Glazier, Byron, NY (US); Jon Mollnow, Perry, NY (US); Douglas Ahrens, Clear Lake, WI (US)

(73) Assignee: Oxbo International Corp., Byron, NY (US)

(21) Appl. No.: 12/552,952

(22) Filed: Sep. 2, 2009

(51) Int. Cl. A01D 45/02

(52) U.S. Cl. 56/104; 56/99; 56/51

(57) ABSTRACT

Stalk rolls are used for a corn harvester having a body, an engine, a cab mounted to the body and a head mounted to a front of the body. The head includes an auger, row separators, corn stalk gathering assemblies between the row separators and ear removal devices. Each ear removal device includes a pair of stalk rolls. Each stalk roll has a core and longitudinally extending flutes spaced about a periphery of the core and extending along the core. Each stalk roll has a straight first section, a second section proximate a first end of the first section and having a first tapering profile, and a third section proximate the second section opposite the first section and having a second tapering profile.

### BACKGROUND OF THE INVENTION

1. Field of the Invention

The present invention is directed to improved stalk rolls as may be used with corn harvesters and in particular to a stalk roll with multiple tapered sections to improve feeding of corn stalks.

2. Prior Art

Prior art corn harvesters include headers with multiple row crop dividing assemblies for directing corn stalks into harvesting gaps defined between the dividing assemblies. Gathering chains or other devices in the gaps draw the stalk toward the header. Stalk rolls, also known as knife rolls, pull the stalks rapidly downward between the stalk and the field. Typically, plates are located above and adjacent the stalk rolls to separate the ears from the stalk and to prevent the ears of corn from passing between the plates. The ears of corn are snapped from the stalk and directed to the combine. It is generally desirable to maintain at least some of the stalks in the field for erosion control and to recycle the plant materials. It is an advantage to chop up the stalk rows to aid in decomposition. Smaller pieces of chopped stalk also tend to eliminate or minimize plugging of tilling tools on the machinery used in the field.

A problem with harvesters is trash on the head and throughout the combine. This can be reduced by improving the feed and handling of stalks. Moreover, improved feeding along the stalk roll improves crushing and crimping of the stalks and conditions residue to reduce wind and water erosion. The improved conditioning also leads to less plugging for fall tillage and provides stalks that are better for bedding and baling. Crushing and crimping treatment of stalks by the harvester also improves field planting conditions. The stalk rolls should also work under a wide variety of stalk and harvesting conditions.

Typical stalk rolls include a core portion with flutes or ridges mounted around the body of the roll, and a nose portion with a helical vane. Such a configuration may include a tapered portion at the leading edge of the stalk roll near the nose portion. Such a configuration has generally been effective at providing feed through the head and combine. However, under certain conditions, the corn stalks do not enter into the pair of knives sufficiently. This may cause plugging and ineffective crimping or crushing that may lead to problems with the harvester and in the field when the stalks are later engaged by other machinery. In addition, it has been found that the stalk rolls may wear better with a tapered design. Although a taper may improve wear, there still may be uneven wear and that such uneven wear may reduce the useful life of a stalk roll.

It can be seen that a new and improved harvester, corn head, and stalk rolls are needed. Such a stalk roll should aid in providing feed of the stalks through the corn head and improving the condition of the stalks remaining in the field. Moreover, such stalk rolls should allow the stalks to enter a sufficient distance between the knife rolls to aid in reducing plugging throughout the harvester head and further in the combine. Such stalk rolls should also reduce uneven wear to increase the life of the stalk rolls. The present invention addresses these as well as other problems associated with combines, corn harvester heads, and stalk rolls.

### SUMMARY OF THE INVENTION

The present invention is directed to stalk rolls for a corn harvester. The harvester includes a head having row dividers that direct corn stalks to ear removal assemblies. An auger at the rear of the head directs ears to the combine portion of the harvester for further processing and separation.

The ear removal assembly includes a gathering assembly having belts with paddles that engage the corn stalks and pull them backward to stalk rolls. The stalk rolls pull the corn stalks downward so that the ears and corn are separated from the corn stalks as they pass between plates above the gathering assembly. Separated ears of corn pass to the auger for further processing. The corn stalks are pulled downward where they are crimped and cut by the stalk rolls and remain in the fields for decomposition to improve treatment of the fields and soil.

Each stalk roll includes an impeller at the leading end of the stalk roll. The stalk rolls are arranged in pairs and rotate in opposite directions to engage the corn stalks and fold them downward between the stalk rolls. The stalk rolls include a substantially cylindrical body and flutes extending outward from a periphery of the cylindrical body at an oblique angle. The edges of the flutes form knifes that cut the corn stalks. The stalk roll is configured with two tapering sections tapering downward from a rear cylindrical portion to the impeller. In one embodiment, the tapering sections are of approximately equal length and the two tapering sections together substantially equal the length of the cylindrical section. The double taper provides for improved feeding and direction of the corn stalks to the rear of the ear removal assembly and to the cylindrical sections of the stalk rolls. Problems related to plugging are reduced with such a configuration while the processing of the corn stalks is maintained and other problems associated with the stalk rolls are reduced.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the views:

FIG. 1 is a top plan view of a harvester according to the principles of the present invention;

FIG. 2 is a perspective view of a corn head for the harvester shown in FIG. 1;

FIG. 3 is a side elevational view of the corn head shown in FIG. 2;

FIG. 4 is a top plan view of a stalk feeder assembly for the corn head shown in FIG. 2;

FIG. 5 is a perspective view of the stalk feeder assembly shown in FIG. 4;

FIG. 6 is a front perspective view of the stalk feeder assembly shown in FIG. 4;

FIG. 7 is a side elevational view of a stalk roll for the stalk feeder assembly shown in FIG. 4;

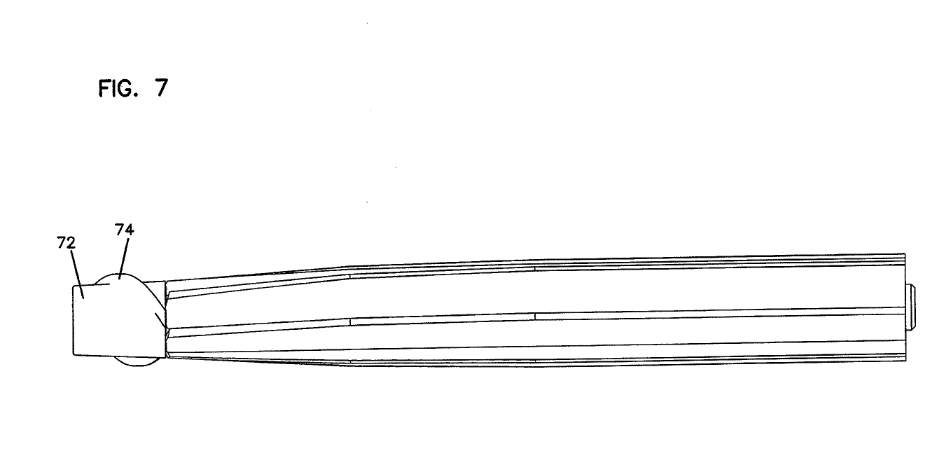

FIG. 8 is a front elevational view of a pair of the stalk rolls shown in FIG. 7;

FIG. 9 is a rear elevational view of the pair of stalk rolls shown in FIG. 8;

FIG. 10 is a perspective view of the pair of stalk rolls shown in FIG. 8; and

FIG. 11 is a top plan view of the pair of stalk rolls shown in FIG. 8.

### DETAILED DESCRIPTION OF THE PREFERRED EMBODIMENT

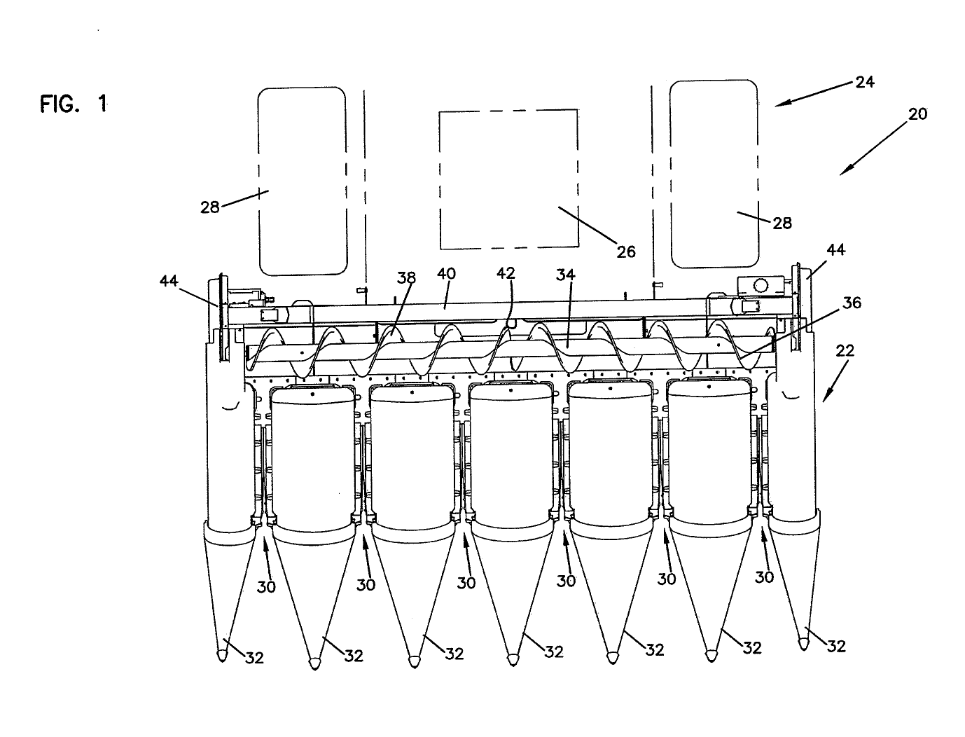

Referring now to the drawings and in particular to FIG. 1, there is shown a harvester, generally designated 20. Head 22 and threshing components are generally designated 24. Harvesters 20 typically include a cab 26 where the operator sits and drives the harvester 20 and operates the various controls. Wheels 28 are typically mounted on the harvester 20 behind the head 22. The head 22 may be interchangeable with other heads for performing other tasks or for use with other crops.

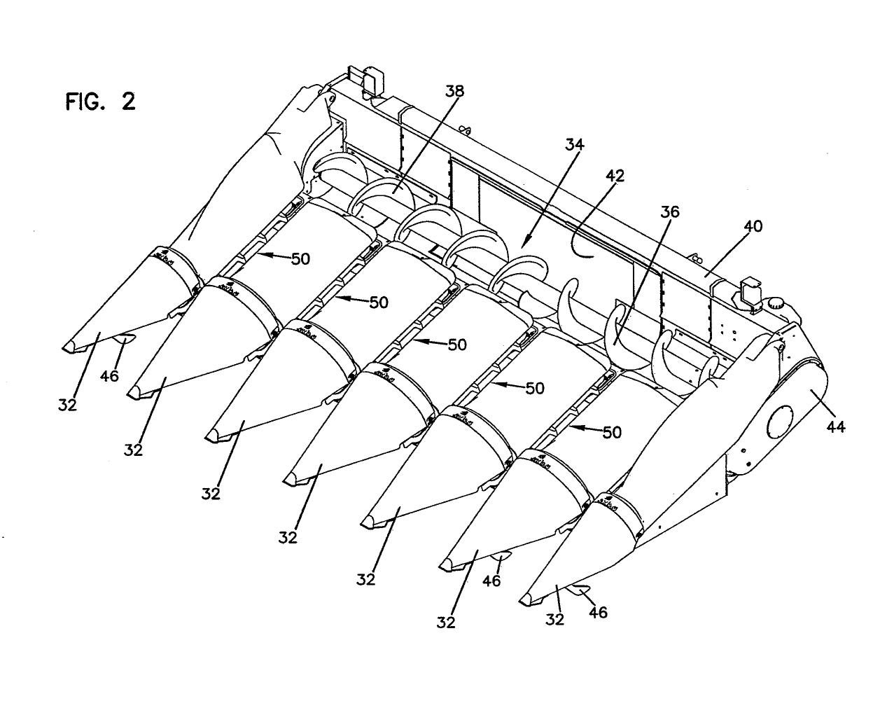

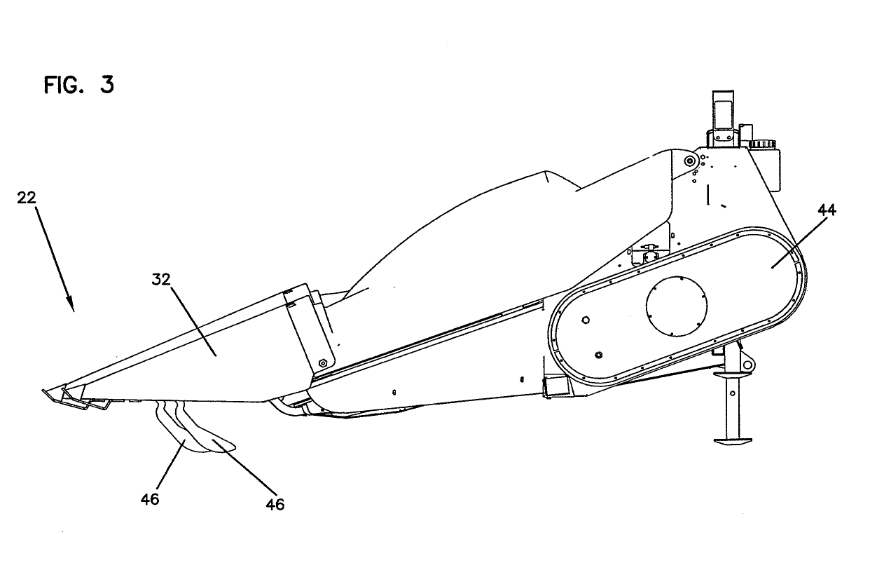

As shown in FIGS. 1-3, the head 22 includes a frame 40. The head 22 is supported on the front of the harvester 20 and also may have skids 46 to maintain the front of the head 20 raised up from the ground. The head 22 includes row dividers 32, which include a cone shaped front portion and provide for directing the corn stalks into ear removal assemblies 30. An auger 34 includes a drive 44 to feed the ears of corn removed from the stalks to an opening 42 from the rear of the head 22. The auger 34 includes a left helical vane 36 and a right helical vane 38 that direct the ears of corn to the center opening 42 for further storage and processing by the harvester 20.

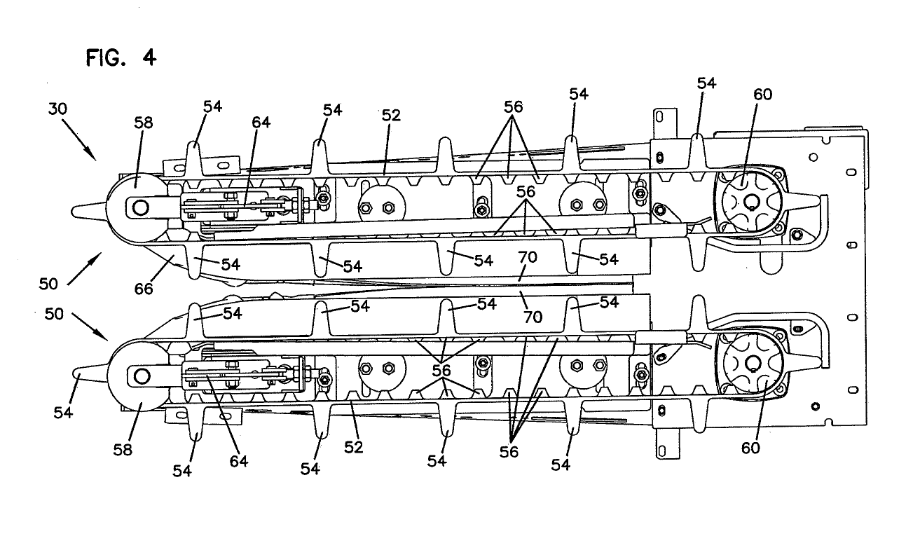

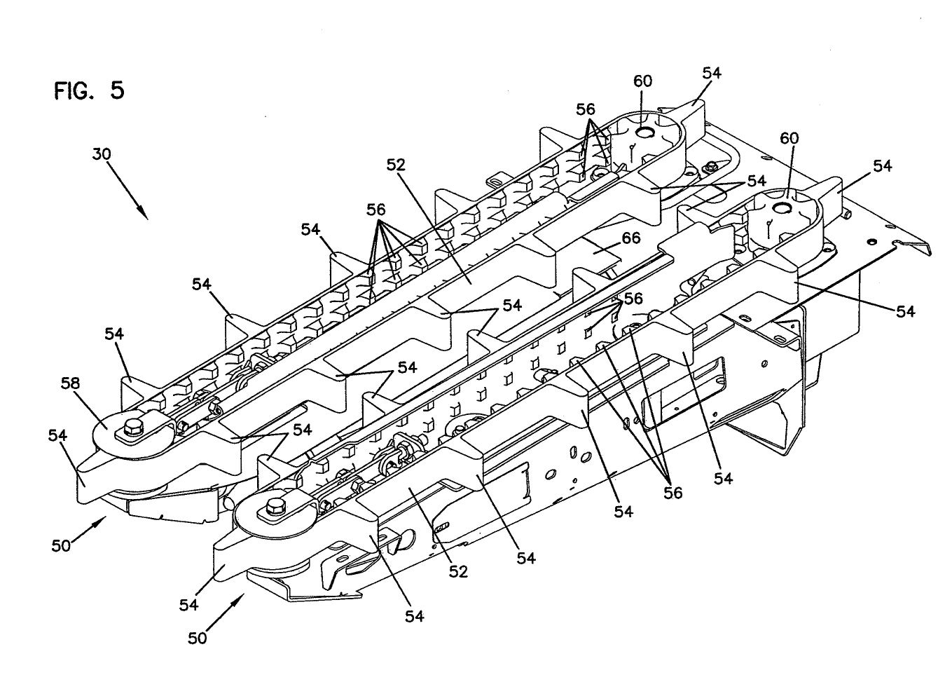

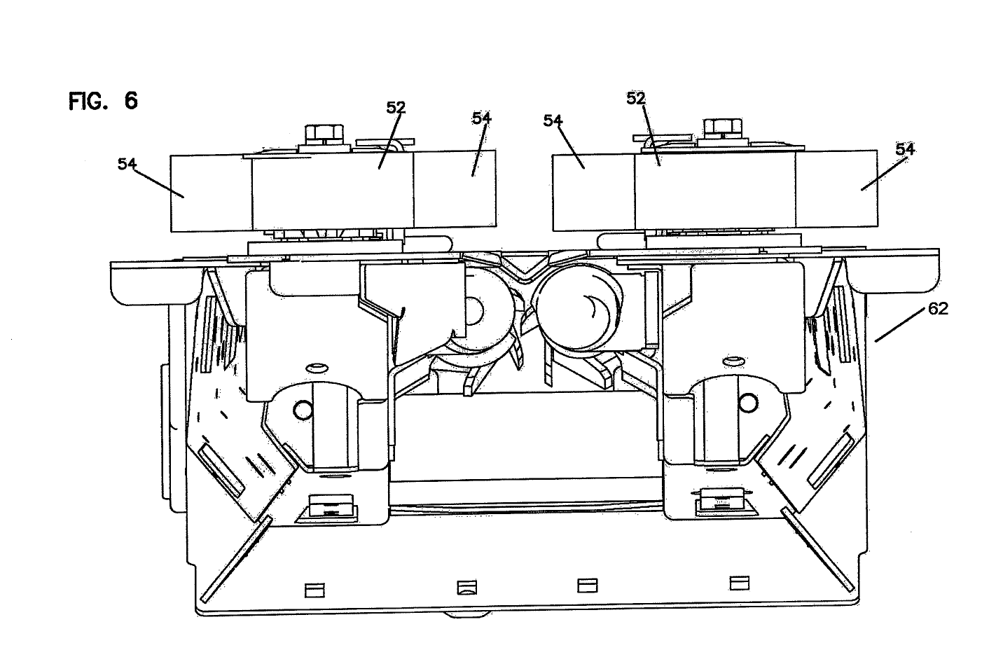

Referring to FIGS. 4-6, the ear removal assembly 30 includes a stalk row gathering assembly 50. The gathering assembly 50 engages corn stalks directed to the ear removal assembly 30 by the row dividers 32. The corn stalks are engaged by paddles 54 on rotating belts 52. The belts 52 include lugs 56 that are driven by drive sprockets 60 and also extend around idler sprockets 58. A motor 62 drives the sprockets 60 and tensioners 64 to maintain proper spacing for tensioning the belt 52. The gathering assembly 50 includes pairs of belts 52 so that the paddles 54 extend toward one another and engage the corn stalks. Although belts 52 are shown, it is also known in the art to use gathering chains with paddles mounted on the chains for engaging the corn stalks. The corn stalks are pulled rearward and the ears of corn engage opposing plates 66 above the gathering assembly 50 and are removed as the stalks are pulled down by the stalk rolls 70, as explained hereinafter. It can be appreciated that the gathering assembly paddles 54 will then push the ears rearward to the auger 34.

In addition to being directed rearward by the gathering assembly 50, the stalks are pulled downward by an opposed pair of stalk rolls 70. The stalk rolls 70 are positioned below the belts 52 of the gathering assemblies 50. The stalk rolls 70 are mounted to rotate about a substantially horizontal axis extending generally along the direction of travel. Each stalk roll 70 includes a center tube 78. Around a periphery of the tube 78 are mounted flutes 76. Each of the flutes 76 has a knife edge 80 that provides for crimping and chopping the stalk rolls for improved treatment prior to the stalk roll 70 being returned to the field. At the front of each stalk roll 70 is an impeller 72 having a helical vane 74. The impeller 72 forms a nose that engages the corn stalks by the vane and directs the stalks rearward. In conjunction with the paddles 54 and the gathering assemblies 50, the stalk rolls 70 are generally pulled rearward to be engaged by the flutes 76 of the stalk roll 70.

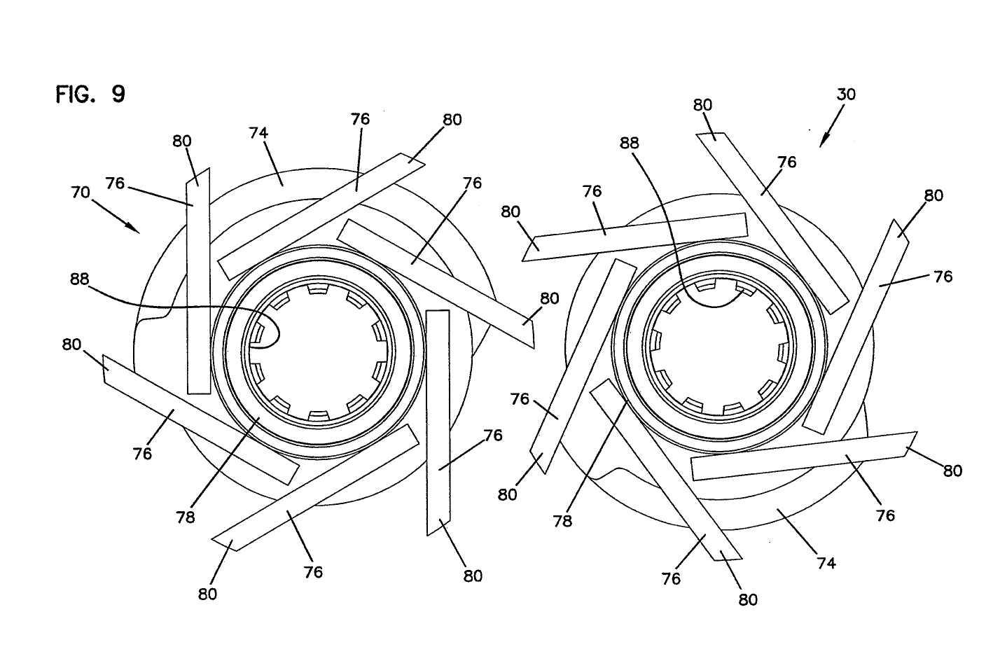

As shown most clearly in FIG. 9, the tube 78 has a keyed inner surface that allows for mounting the stalk roll 70 to a drive 60 and to impart rotation to each stalk roll 70.

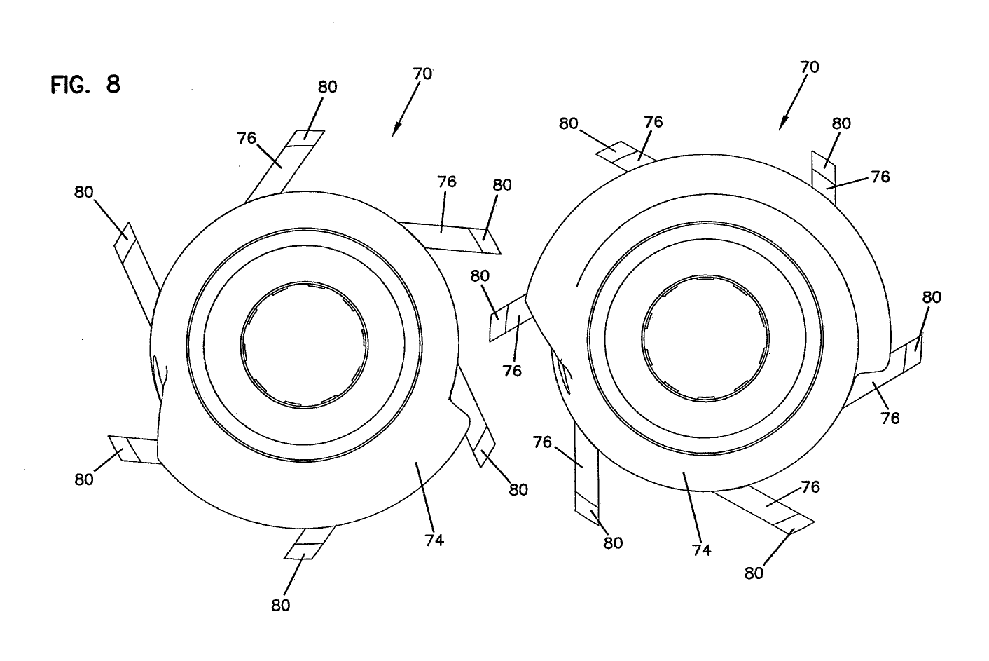

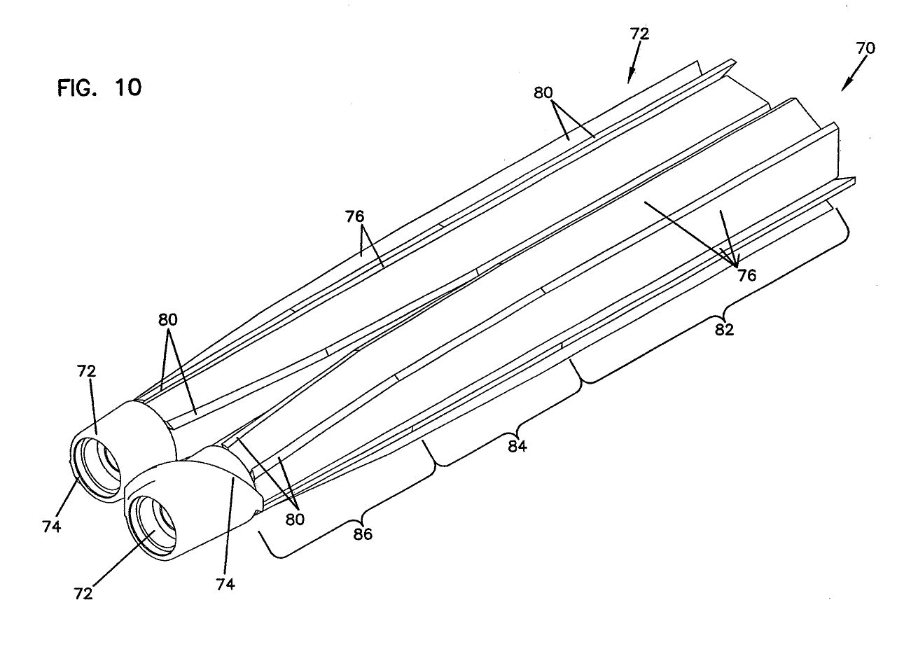

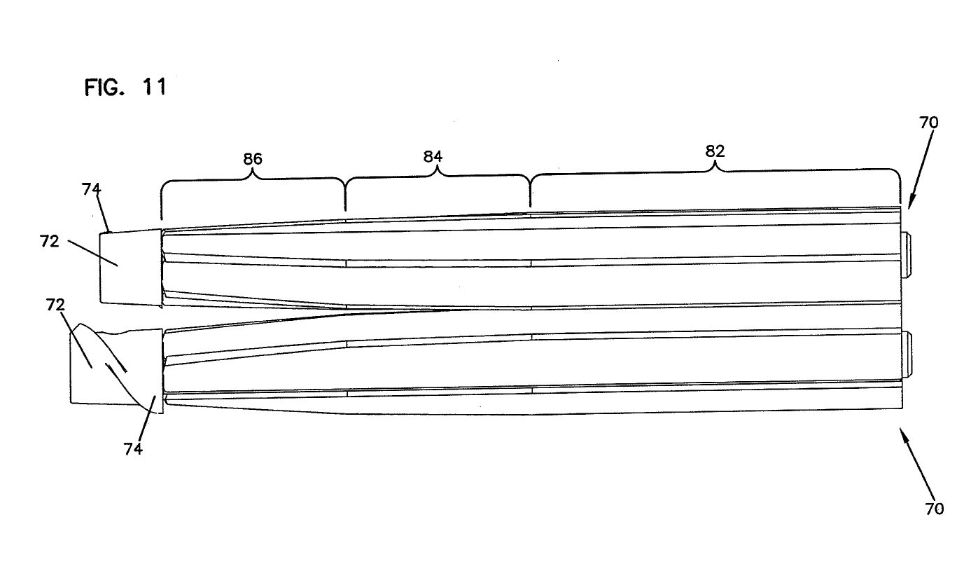

Referring now to FIGS. 10 and 11, each stalk roll 70 behind the impeller 72 includes three sections. A first section 82 is substantially cylindrical. A second section 84 is tapered at a first angle and a third section 86 is tapered at a second angle greater than the first angle. In one embodiment, the first section 82 is approximately 12 inches long; the second section 84 is approximately 6 inches long and the third section 86 is also approximately 6 inches long. A typical diameter to the outer edge of the knife edges 80 is approximately 3.5 inches in one embodiment. The taper from the first section 82 would be from approximately 3.5 inches to approximately 3.25 inches. The taper in the third section 86 would be from approximately 3.25 inches to approximately 2.5 inches. In addition, it can be appreciated that in one embodiment, the stalk roll 70 includes six flutes 76 and that the flutes 76 have a substantially constant width but taper along the body of the stalk roll 70. Moreover, as shown in FIGS. 8 and 9, the flutes 76 extend at an oblique angle relative to a radius of the stalk roll 70. Therefore with six flutes 76, the angle between adjacent flutes is approximately 60°.

In operation, the harvester 20 is generally advanced along a direction of travel following the rows of the corn field. The row dividers 32 are positioned to extend between the rows so that the corn stalks are directed to the ear removal assemblies 30. As the corn stalk is at the front of the gathering assembly 50, the paddles 54 on the belt 52 engage the stalk and pull it rearward. In addition, below the gathering assembly 50, the impeller 72 of the stalk roll 70 engages the corn stalks and pulls them rearward. As the paddles 54 continue to push the corn stalk rearward, the stalks are engaged by the stalk roll 70. The pairs of stalk rolls 70 are rotated in opposite directions so that the stalk rolls 70 pull downward when positioned between each pair of stalk rolls 70.

When the corn stalks are engaged by the stalk rolls 70, the flutes 76 pull the stalk rolls 70 downward. This engagement and motion accomplishes several things. As the stalks are pulled downward, the ears engage the plates 66. The distance between the plates 66 is smaller than the width of the ears of corn. Therefore, ears of corn are separated from the stalk. The separated ear is pushed backward by the continued rearward to be engaged by the auger 34 and is fed to the other components of the harvester combine 20. In addition, the stalks themselves are treated by the stalk rolls 70 and the flutes 76 and the knife edges 78. The knife edges 78 chop the stalk rolls 70 for the flutes 76 crimp the corn stalks as they are pulled downward between the bodies of the stalk rolls 70. After the stalk rolls 70 are pulled downward, they are left in the field to decompose. The crimping aids in the decomposition to provide for better treatment of the treatment for future planting. The cutting leaves smaller pieces in the field, which also aids in decomposition and provides for better treatment of the soil and decomposing corn stalks that are left in the field.

It has been found that the double taper also provides for smoother transitions as the corn stalk is pulled further along the body of the stalk roll 70 than conventional knife rolls. Therefore first and second tapered sections 84 and 86 provide for smoother movement of the corn stalks rearward and decrease the plugging problems associated with the prior art. It has also been found that the double taper leads to improved wear from better feeding of the corn stalks rearward.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A stalk roll, comprising:
a core having a longitudinal direction;
a plurality of longitudinally extending flutes spaced about a periphery of the core and extending along the core, each of the flutes having a straight first section, a second section proximate a first end of the first section and having a first profile tapering at a first angle relative to the longitudinal direction, and a third section proximate the second section opposite the first section and having a second profile tapering at a second angle relative to the longitudinal direction.

2. A stalk roll according to claim 1, further comprising an impeller portion proximate the third section.

3. A stalk roll according to claim 1, wherein the second angle is greater than the first angle.

4. A stalk roll according to claim 1, wherein the stalk roll comprises six flutes spaced about the periphery of the core.

5. A stalk roll according to claim 1, wherein the core comprises a tube.

6. A stalk roll according to claim 5, wherein the flutes attach about a periphery of the tube.

7. A stalk roll according to claim 2, wherein the impeller portion includes a helical vane.

8. A stalk roll according to claim 2, wherein the impeller portion comprises a conical portion.

9. (canceled)

10. A corn harvester head, comprising:
an auger;
a plurality of row separators;
a plurality of gathering assemblies;
a plurality of ear removal devices;
a plurality of pairs of stalk rolls, each stalk roll comprising:
a core having a longitudinal direction;
a plurality of longitudinally extending flutes spaced about a periphery of the core and extending along the core, each of the flutes having a straight first section, a second section proximate a first end of the first section and having a first profile tapering at a first angle relative to the longitudinal direction, and a third section proximate the second section opposite the first section and having a second profile tapering at a second angle relative to the longitudinal direction.

11. A corn harvester head according to claim 10, the plurality of flutes extending outward about a periphery of the stalk roll.

12. A corn harvester head according to claim 11, wherein the flutes of a first stalk roll of each pair of stalk rolls extend in a first annular direction and the flutes of a second stalk roll of each pair of stalk rolls extend in a second annular direction opposite to the first annular direction.

13. A corn harvester head according to claim 11, comprising an impeller proximate the third section, wherein the impeller of a first stalk roll of each pair of stalk rolls spirals in a first direction the impeller of a second stalk roll of each pair of stalk rolls spirals in a second direction opposite the first direction.

14. A harvester, comprising:
a body;
an engine;
a cab mounted to the body;
a corn harvester head mounted to a front of the body, the head comprising:
an auger;
a plurality of row separators;
a plurality of gathering assemblies;
a plurality of ear removal devices;
a plurality of pairs of stalk rolls, each stalk roll comprising:
a core having a longitudinal direction;
a plurality of longitudinally extending flutes spaced about a periphery of the core and extending along the core, each of the flutes having a straight first section, a second section proximate a first end of the first section and having a first profile tapering at a first angle relative to the longitudinal direction, and a third section proximate the second section opposite the first section and having a second profile tapering at a second angle relative to the longitudinal direction.

15. A corn harvester according to claim 14, the plurality of flutes extending outward about a periphery of the stalk roll at an oblique angle to the core.

16. A corn harvester head according to claim 15, wherein the flutes of a first stalk roll of each pair of stalk rolls extend in a first annular direction and the flutes of a second stalk roll of each pair of stalk rolls extend in a second annular direction opposite to the first annular direction.

17. A pair of corn stalk rolls, each stalk roll comprising:
a core having a longitudinal direction;
a plurality of longitudinally extending flutes spaced about a periphery of the core and extending along the core, each of the flutes having a straight first section, a second section proximate a first end of the first section and having a first profile tapering at a first angle relative to the longitudinal direction, and a third section proximate the second section opposite the first section and having a second profile tapering at a second angle relative to the longitudinal direction;
a plurality of flutes extending outward about a periphery of the stalk roll at an oblique angle to the core, the flutes of a first stalk roll of each pair of stalk rolls extending in a first annular direction and the flutes of a second stalk roll of each pair of stalk rolls extending in a second annular direction opposite to the first annular direction; and
an impeller portion proximate the third section, the impeller of the first stalk roll of each pair of stalk rolls spiraling in a first direction and the impeller of a second stalk roll of each pair of stalk rolls spiraling in a second direction opposite the first direction.
